(19) United States
(12) Patent Application Publication
(10) Pub. No.: US 2003/0095037 A1
(43) Pub. Date: May 22, 2003

(54) Image-forming apparatus and control method therefor

(76) Inventor: Fumihiro Ueno, Shizuoka (JP)

Correspondence Address: MORGAN & FINNEGAN, L.L.P., 345 PARK AVENUE, NEW YORK, NY, 10154, US

(21) Appl. No.: 10/298,730

(22) Filed: Nov. 18, 2002

(30) Foreign Application Priority Data
Nov. 22, 2001 (JP) 2001-357780

(51) Int. Cl. H04M 11/04

(52) U.S. Cl. 340/310.01

(57) ABSTRACT

A printer control circuit has a power unit control circuit, a printer controller and a printer engine. The power unit control circuit has a spread spectrum communication circuit and a power control unit. The printer controller converts data received by the spread spectrum communication circuit into printable data and supplies the printable data to the printer engine. The spread spectrum communication circuit receives data from an information processing apparatus via a power line and the power control unit turns power to the printer engine ON/OFF according to the data received by the spread spectrum communication circuit.

### FIELD OF THE INVENTION

The present invention relates to an image-forming apparatus and a control method therefor.

### BACKGROUND OF THE INVENTION

Typically, when one wishes to print out text or graphic data produced on a personal computer onto paper or some other media, the image-forming apparatus, which may be a printer, is connected to the personal computer via communication and control lines.

Similarly, where a plurality of personal computers use the same image-forming apparatus such as in an office setting or the like, the personal computers and the printer are typically connected by a local area network (LAN) upon installation.

Lately, wireless adapters have been used instead of communications and control lines, with printing carried out by wireless systems such as IEEE802.11b and Bluetooth via the adapter. Such a configuration can be seen, for example, in U.S. Pat. No. 5,481,249, which shows a printer that receives data via a power line.

In order to further an understanding of the distinctive features of the present invention, a description will first be given of the operation of an image-forming apparatus of the related art in which printing is executed from a personal computer, using the example of an image-forming apparatus that forms a color image by electrophotography.

FIG. 1 is a block diagram of a control mechanism of an image-forming apparatus of the related art.

As shown in the diagram, the image-forming apparatus, which in this case is a printer, and the personal computer are connected by a communications and control line 101.

The electrophotographic printer is composed of a printer controller 2 and a printer engine 3, with print data transmitted from the personal computer received at the printer controller 2 communications processor 12 and the printer engine 3 converting the print data into a printable form.

In the case of a color image, the printer engine 3 forms a color image according to instructions from the printer controller 2 by causing a printing sequence control circuit 25 to successively turn ON and OFF (1) a high-voltage unit provided in order to apply a transfer bias to a transfer printing electrostatic charge unit and to provide a development bias to a development unit as well as (2) a static high-voltage unit provided in order to form a latent image on a photosensitive drum.

In FIG. 1, reference numeral 2 denotes the printer controller. The printer controller 2 includes a communications processor 12 that receives data from the personal computer via the communications and control line 101, a data buffer 3 that stores the data received and an image processor 11 that converts RGB data into YMCK data, performs masking or γ-conversion for optimum color reproduction, and converts the data into data that can be printed by the printer engine 3 and transmits print instructions and print data to the printer engine 3 via the graphic interface 31.

Reference numeral 3 denotes the printer engine, and includes the image processor 11, a print drive control circuit 22, a bias control circuit 23, a paper supply transport control circuit 24, a printing sequence control circuit 25 and an adhesive unit control circuit 27.

An image-forming unit 21 generates a graphic signal 33 based on the color image signal transmitted from the printer controller 2 and outputs the graphic signal 33 to the print drive control circuit 22.

The print drive control circuit 22 drives a semiconductor laser (not shown in the diagram) and outputs a laser drive signal 36.

The printing sequence control circuit 25 reads out from a memory device not shown in the diagram the parameters necessary for printing, such as the process conditions (bias), paper size, paper type and so forth, and outputs same as (1) printing sequence signals 35 to the paper supply transport control circuit 24 from the image-forming unit 21 via a bus 32 and (2) activation signals 34 to the bias control circuit 23.

The paper supply transport control circuit 24 outputs motor, clutch and solenoid actuator drive signals 38 in response to the printing sequence signals 35 and to sensor information not shown in the diagram, and supplies a media such as paper in order to perform proper printing.

The bias control circuit 23, in response to the activation signals 34, outputs bias signals 37 to the high-voltage units such as the transfer/development units, develops the electrostatic potential image and transfers it to the recording paper in order to form a full color image.

It should be noted that the communications processor 12 reports the printer status, including information in the printer controller, to the personal computer via the communications and control line 101.

In addition, reference numeral 4 denotes the power unit control circuit, which generates DC electricity from the AC electricity input from a power line. The power unit control circuit 4 supplies power to the parts of the apparatus, and also generates power to activate the halogen heater of the adhesive unit. A power circuit 52 and a cable 72 and outlet 71 are connected to an existing power line. Then, when a user turns ON a printer power switch (not shown in the diagram), power supply signals 76, 78 and 79 are simultaneously turned ON to the printer controller 2, the printer engine 3 and the adhesive unit control circuit 27, by which the printer is maintained in a power ON state.

Next, in order to further an understanding of the present invention a description will be given of the sequence for carrying out image formation in a printer in the related art.

FIG. 2 is a flow chart showing the operation of a printer in the related art.

As shown in the diagram, when the user first turns the power switch ON, the power unit control circuit 4 supplies power to the control boards (printer controller 2, printer engine 3, adhesive unit control circuit 27). Then, the printer controller 2 and the printer engine 3 initialize the hardware circuits and communications.

Thereafter, the process proceeds to a step S11, in which the printer engine 3 executes initialization processes, for example, developer cartridge and photosensitive drum check, drive system initialization, drum and intermediate transfer cleaning and adhesive heater activation to standby temperature, in short, putting the printer in standby mode.

Next, in a step S13, the printer engine 3 waits for the adhesive temperature to reach a target temperature and to enter a standby mode. When the printer engine 3 is in that standby mode, the printer engine 3 checks information from a paper detection sensor not shown in the diagram that detects the presence (or absence) of paper in a step S14. If there is paper, then the process proceeds to a step S15. If there is no paper, then the process returns to a step S13. It should be noted that, in a standby mode as well, the adhesive heater continues to be adjusted so as to maintain standby temperature.

Next, if there is paper, in step S15, the printer engine 3 checks whether or not there is an instruction to print from the printer controller 2, and if so, in a step S16 the printer engine 3 resets the adhesive heater target temperature to print adhesion temperature and executes an electrophotography process printing sequence to print out an optimum image. When printing is completed in a step S17, the printer engine 3 resets the adhesive heater target temperature to standby temperature, returns the drive system to a desired standby position and repeats the operation described above from step S13.

Thus, as described above, when an instruction to print has been sent from the personal computer to the printer controller 2 and after processing internal to the printer controller 2 in accordance with the instruction to print has been completed, an instruction to print is transmitted from the printer controller 2 to the printer engine 3 and in step S15 it is determined that there is an instruction to print.

However, it takes time, money and effort to install communications and control lines in order to use an image-forming apparatus from a personal computer or other information processing apparatus.

In addition, in order to be able to begin printing promptly when an instruction to print from the personal computer is received, the image-forming apparatus must maintain the supply of power to all control circuits. Moreover, in the case of electrophotographic types of image-forming apparatuses, the adhesive heater temperature must be maintained. Accordingly, such apparatuses unnecessarily consume a certain amount of power and unnecessarily generate a certain amount of heat.

### SUMMARY OF THE INVENTION

Accordingly, the present invention is proposed to solve the above-described problem of the conventional art, and has as its object to provide an image-forming apparatus the time, money and effort needed to install communications and control lines are eliminated, by eliminating the need for wire connections altogether.

Another and further object of the present invention is to provide an image-forming apparatus that achieves power consumption and heat energy reductions equivalent to having the power off when the apparatus is in a standby mode.

The above-described,object of the present invention is achieved by an image-forming apparatus comprising:

a reception unit for receiving data via a power line;

an image-forming unit for forming an image according to the data received by the reception unit; and

a power control unit for controlling power supply to the image-forming unit according to the data received by the reception unit.

In addition, the above-described objects of the present invention are also achieved by a control method for controlling an image-forming apparatus, the method comprising the steps of:

receiving data via a power line using a reception unit;

forming an image according to the data received by the reception unit using an image-forming unit; and

controlling power supply to the image-forming unit according to the data received by the reception unit using a power control unit.

Other objects and advantages besides those discussed above shall be apparent to those skilled in the art from the description of preferred embodiments of the invention that follows. In the description, reference is made to accompanying drawings, which form a part thereof, and which illustrate examples of the invention. Such examples, however, are not exhaustive of the various embodiments of the invention, and therefore reference is made to the claims that follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention, in which:

FIG. 1 is a block diagram of a control mechanism of an image-forming apparatus of the related art;

FIG. 2 is a flow chart showing the operation of a printer in the related art;

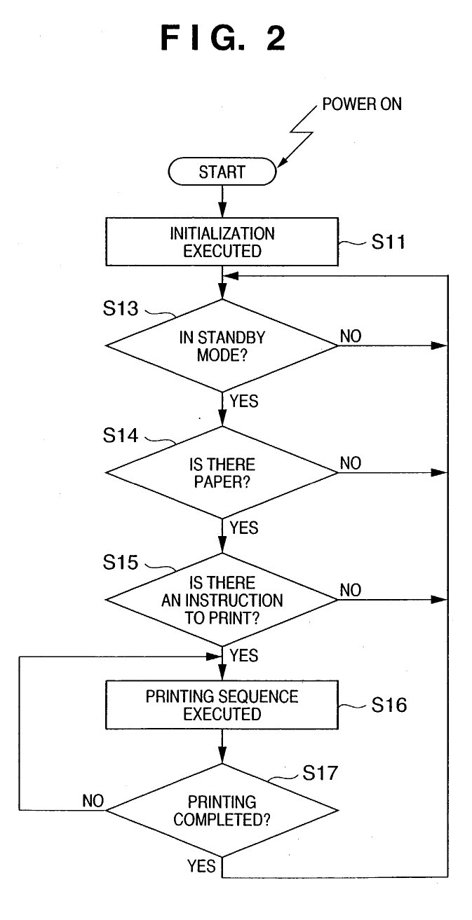

FIG. 3 is a block diagram of the composition of a control mechanism of an image-forming apparatus according to one embodiment of the present invention;FIG.

FIG. 4 is a flow chart showing steps in a printing operation of a first embodiment of the present invention;

FIG. 5 is a flow chart showing processes performed by a power control unit of a first embodiment of the present invention;

FIG. 6 is a condition table for switching ON/OFF a power supply portion at a power supply unit according to a second embodiment of the present invention;

FIG. 7 is a flow chart showing processes performed by a power control unit in a fourth embodiment of the present invention; and

FIG. 8 is a flow chart showing steps in a printing operation of a fifth embodiment of the present invention.

### DETAILED DESCRIPTION OF THE PREFERRED EMBODIMENTS

Preferred embodiments of the present invention will be described in detail in accordance with the accompanying drawings.

It should be noted that although the present embodiment is described using an electrophotographic printer as an example of the image-forming apparatus that forms a color image, in fact the present invention can be adapted to other types of printers such as, for example, an ink jet printer. In addition, it is possible to use the image-forming apparatus control method in the form of a recording medium such as a CD-ROM storing a program for achieving such a method in a variety of types of image-forming apparatuses.

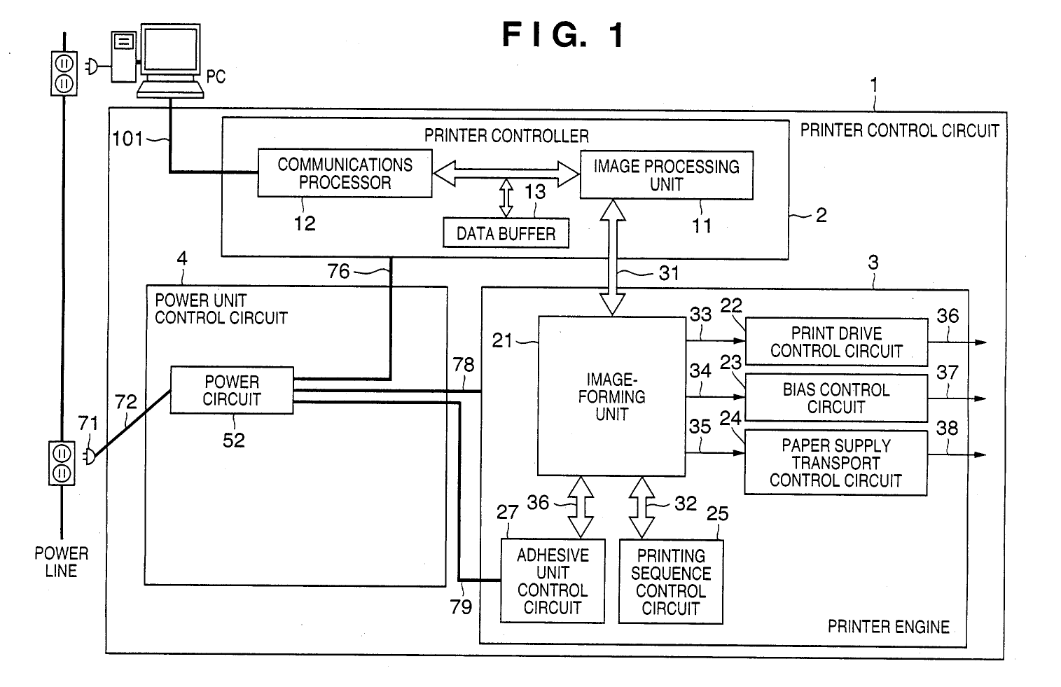

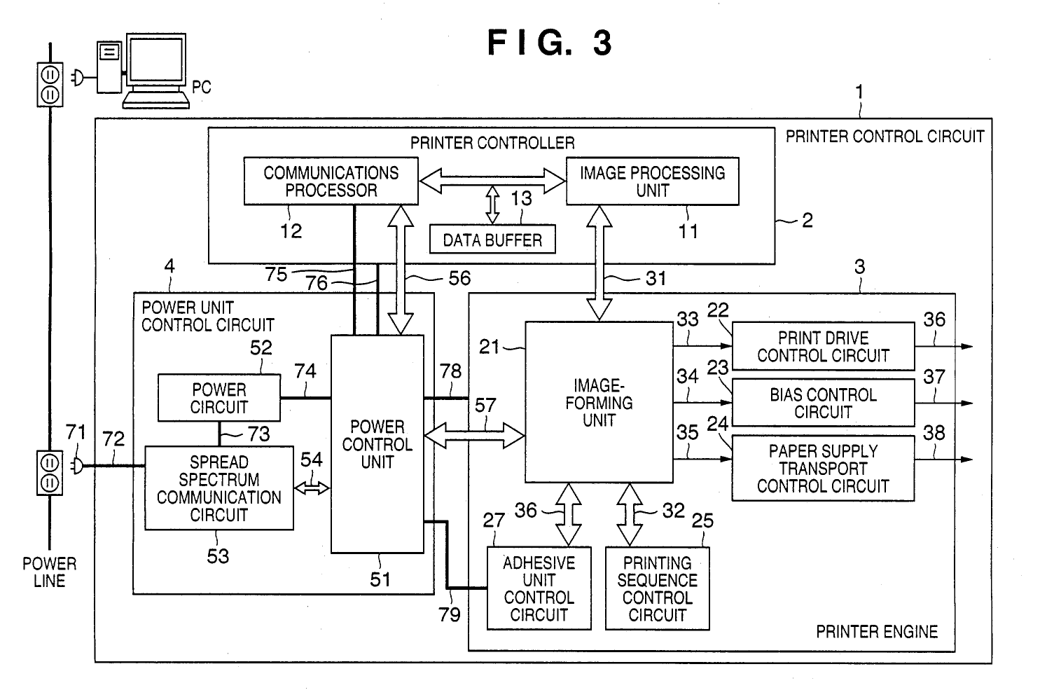

FIG. 3 is a block diagram of the composition of a control mechanism of an image-forming apparatus according to one embodiment of the present invention. It should be noted that parts having the same functions as those described in FIG. 1 are given the same reference numerals. In addition, when it is desirable to print text and image data produced with information processing apparatuses such as personal computers and the like to a recording medium such as paper, then when installing the image-forming apparatus (a printer or the like) and the personal computer, the image-forming apparatus and the personal computer can be communicably connected to each other simply by plugging them into a wall socket, making printing possible.

In FIG. 3, reference numeral 53 is a spread spectrum communication circuit. The spread spectrum communication circuit 53 spreads information from the personal computer by a spread code and despreads information from the power line and receives same as data, and also spreads image-forming apparatus status information using the spread code and transmits the spread image-forming apparatus status information to the personal computer data via the power line.

Reference numeral 51 is a power control unit. The power control unit 51 determines whether or not the data received via the spread spectrum communication circuit 53 (path 54) has the station address of the apparatus itself, and also determines what type of data it is. In addition, the power control unit 51 switches the supply of power ON/OFF to those parts of the image forming apparatus that need power, sends data and information to the printer controller 2 (path 56), receives information on the status of the image-forming unit 21 (path 57), transmits data to the personal computer via the spread spectrum communication circuit 53, and, for example, transmits instructions such as the target adhesive temperature to the image-forming unit 21 (path 57).

As noted above, reference numeral 52 is a power circuit. By coupling an outlet 71 and a cable 72 extending from the power circuit 52 via the spread spectrum communication circuit 53 to an existing power line and turning a printer power switch (not shown in the diagram) ON, power supply signals 73 and 74 are turned ON to the spread spectrum communication circuit 53 and the power control unit 51, respectively. It should be noted that the power consumption of the spread spectrum communication circuit 53 and the power control unit 51 is very small, approximately equivalent to when the power is turned OFF. In addition, the supply of power to the power supply units is carried out by the power control unit 51 turning the power supply signals 75, 76, 78 and 79 ON/OFF to the communications processor 12, the printer controller 2, the printer engine 3 and the adhesive unit control circuit 27, respectively.

It should be noted that the personal computer side is also similarly equipped with a spread spectrum communication circuit 53 that spreads the data to be transmitted to the image-forming apparatus by a spread code via the power line and similarly despreads the spread code-spread data received at the image-forming apparatus via the power line so as to obtain status information.

The data transmitted from the personal computer is received by the spread spectrum communication circuit 53, and is transmitted to the image processor 11 via the power control unit 51 and the communications processor 12. The image processor 11 then processes the data into print data that can be used for printing by the printer engine 3, after which the image processor 11 sends a print instruction to the printer engine 3, and further, supplies print data to the printer engine 3. The printer engine 3 then forms an image on the recording medium in accordance with the print data.

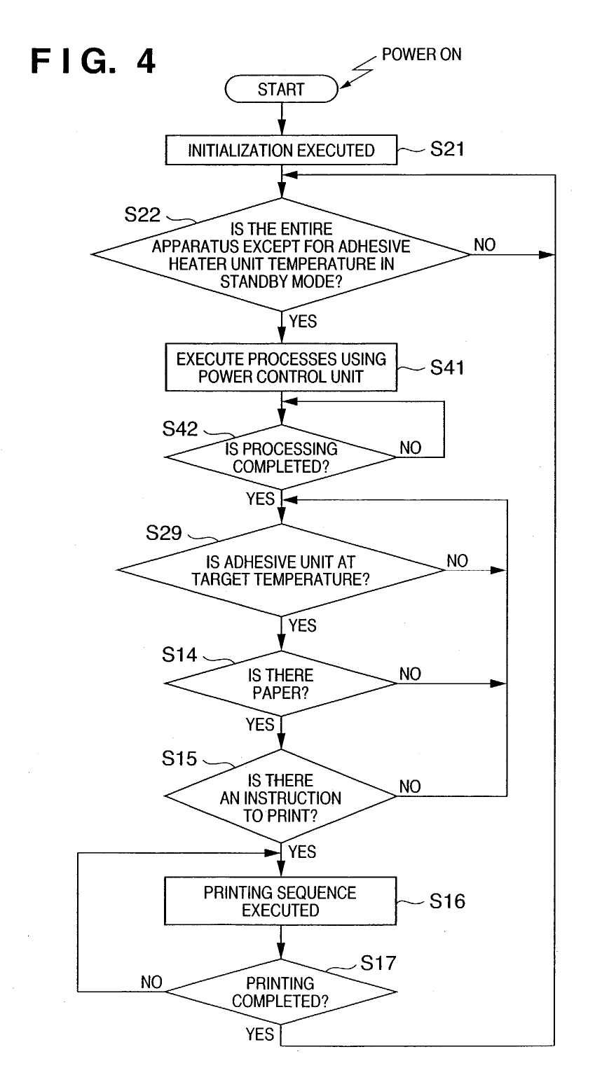

A description will now be given of the operation of the printer engine 3 according to the present invention, with reference to FIG. 4.

FIG. 4 is a flow chart showing steps in a printing operation of a first embodiment of the present invention.

When a power switch (not shown in the diagram) is turned ON, the power circuit 52 turns ON the power supply signal 74 to the power control unit 51. Power is then supplied from the power control circuit 51 to the control boards (the printer controller 2, the communications processor 12, the printer engine 3), and hardware circuit and communications initialization settings are carried out at the printer controller 2 and the printer engine 3.

Thereafter, the process proceeds to a step S21, where the printer engine 3, in accordance with instructions from the power control unit 51, executes start-up processes, for example, checking for the presence of a developer cartridge and a photosensitive drum, initializing the drive system, and cleaning the drum and intermediate transfer medium (the so-called electrophotography process initialization).

However, at this time, the adhesive unit control circuit 27 does not adjust the temperature of the adhesive heater to the standby temperature but completes all other processes, at which time all but the adhesive heater is put into the equivalent of standby mode (in a step S22).

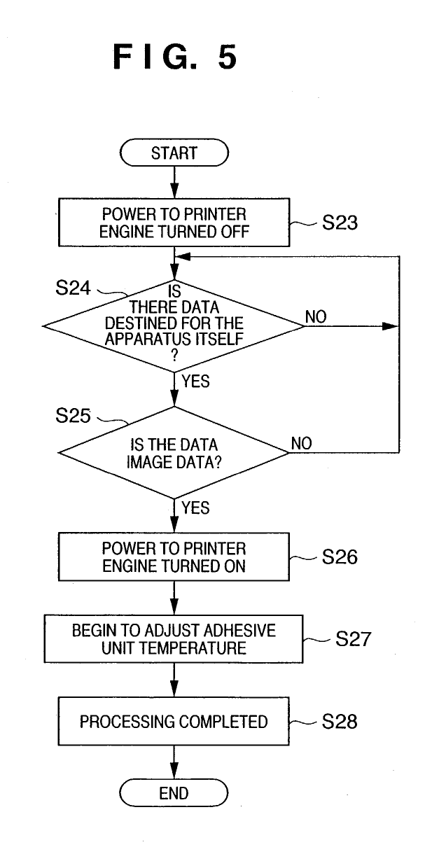

Thereafter, when the equivalent of standby mode is reached, the process proceeds to a step S41, in which the power control unit 51 is notified that all but the adhesive heater are in standby mode and at which completion by the power control unit 51 is awaited. In such state are predetermined processes executed by the power control unit 51. During this step S41, the powered parts are switched ON/OFF and data reception is monitored. A more detailed description of these processes is provided with reference to FIG. 5 later.

When the power control unit 51 completes the above-described processes in a step S42, the overall process proceeds to a step S29, in which the printer engine 3 adjusts the temperature of the adhesive heater and the process waits for the adhesive heater to reach the desired temperature (that is, the standby temperature) in step S29. When the adhesive heater does reach the desired temperature, the printer engine 3 in step S14 checks for a signal from a paper detection sensor (not shown in the diagram) that detects the presence of paper. If there is paper, then the process proceeds to step S15. If there is no paper, then the process proceeds to step S29.

In step S15, the printer engine 3 checks if there is an instruction to print from the printer controller 2, and if there is an instruction to print, proceeds to step S16, resets the target temperature of the adhesive heater to a print adhesive temperature and electrophotographically prints out an optimum image. The print data of step S16 is supplied from the printer controller 2 to the printer engine 3. When printing is completed in step S17, the printer engine 3 returns to the drive system to a desired standby position and repeats processes from step S22. At this time the target temperature of the adhesive heater is reset to the standby temperature, which is used in step S29.

A detailed description will now be given of the processes performed by the power control unit 51 in step S41 shown in FIG. 4, with reference to FIG. 5.

FIG. 5 is a flow chart showing processes performed by a power control unit of a first embodiment of the present invention.

As shown in the diagram, when the process begins, the power control unit 51 turns the supply of power to the printer engine 3 and the adhesive unit control circuit 27 OFF (step S23). By so doing, signals to the drive system, adhesive heater adjustment and all varieties of high voltage electric power are turned OFF.

Next, the process proceeds to a step S24, in which the apparatus checks for data destined for the apparatus itself from the personal computer via the spread spectrum communication circuit 53. At this point, if the IP address attached to the data received at the spread spectrum communication circuit 53 is the station address of the apparatus itself, then the apparatus determines that there is data received.

Here, if the data destined for the apparatus itself (that is, YES in step S24), then the process proceeds to step a S25, where it is determined whether or not the data is image data. In other words, the power control unit 51 has the ability to check the address of the data received by the spread spectrum communication circuit 53 as well as to determine whether such data is image data or not.

If the data so received is determined to be image data (that is, YES in step S25), then the data received is sent to the printer controller 2 and the supply of power to the printer engine 3 and the adhesive unit control circuit 27 is turned ON (in a step S26) without waiting for the data to be converted at the printer controller 2. Similarly, the power control unit 51 begins to instruct the printer engine 3 to adjust the temperature of the adhesive heater (in a step S27) and completes processing by, for example, setting a process-complete flag (FLG) in a step S28, thus completing processing by the power control unit 51. The printer engine 3 is thus put into a print-enable mode and begins processing.

Thereafter, the process of converting the image data received at the printer controller 2 is carried out to the extent of executing the printing sequence in step S16. The image data received by the spread spectrum communication circuit 53 is then sent from the power control unit 51 to the communications processor 12 via the path 56. Similarly, the data conversion process at the image processor 11 may for example be the process of converting RGB data into YMCK data, the masking and γ-conversion for optimum color processing into printable data at the printer engine 3.

In other words, the power control unit 51 takes data received and sends it as image data destined for the apparatus itself to the printer controller 2. The printer controller 2 converts the image data received from the power control unit 51 into data that can be printed by the printer engine 3. When such processing is completed, the power control unit 51 issues an instruction to print to the printer engine 3 and at the same time also supplies the converted data to the printer engine 3. The printer engine 3 then prints the data supplied from the printer controller 2 in the printing sequence of step S16.

Similarly, if the data received is image data destined for the apparatus itself, then the power control unit 51 turns the power to the printer controller 2 ON and the printer engine 3 adjusts the temperature of the adhesive heater. In other words, adjustment of the temperature of the adhesive heater and image processing at the printer controller 2 (image processor 11) are carried out in parallel.

A description will now be given of an image-forming apparatus according to a second embodiment of the present invention, with reference to the accompanying drawings.

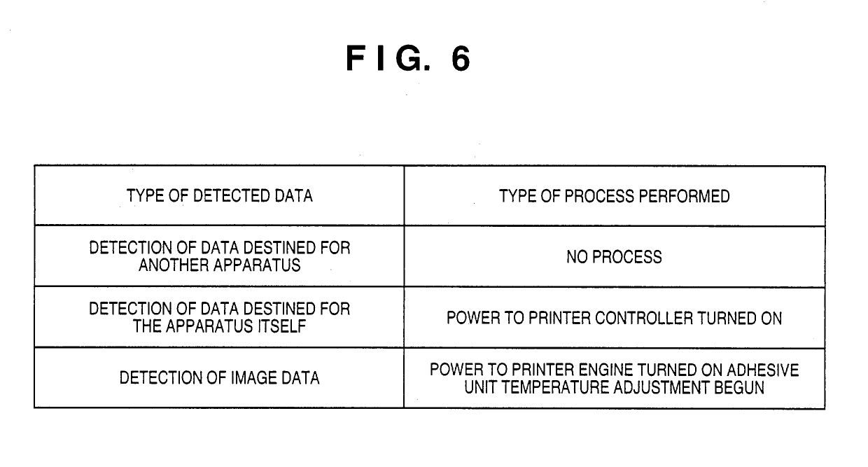

FIG. 6 is a condition table for switching ON/OFF a power supply portion at a power supply unit according to a second embodiment of the present invention.

As shown in the diagram, the power control unit 51 first determines whether or not the data is destined for the apparatus itself and whether or not the data is image data, and turns ON the power to those powered parts that should be powered. That is, if the data received via the spread spectrum communication circuit 53 has the station address of the apparatus itself, then the power control unit 51 turns ON the power to the printer controller 2, and further, if the data is image data, then the power control unit 51 turns ON the power to the printer engine 3 and begins to adjust the temperature of the adhesive heater.

Using FIG. 5 to describe the image-forming apparatus of the present invention, the power control unit 51, in step S23, turns OFF power to the printer engine 3 (including the adhesive unit control circuit 27) and the printer controller 2, and in step S24, when it is determined that the data received has the station address of the apparatus itself, turns ON power to the printer controller 2. Further, in step S25, when it is determined that the data received is image data, the power control unit 51, in step S26, turns ON the power to the printer engine 3 (including the adhesive unit control circuit 27). The printer engine 3 then begins to control the adhesive heater.

In other words, compared to the processes of FIG. 5, the image-forming apparatus according to the second embodiment of the present invention adds the turning OFF of power to the printer controller 2 in step S23, and between steps S23 and S24, adds the turning ON of power to the printer controller 2.

The personal computer and the image-forming apparatus are connected to the power unit control circuit 4, so when there is an instruction to print from the personal computer data is transmitted from the power control unit 51 to the printer controller 2. At the same time, processing instructions for printing are also transmitted from the power control unit 51 to the printer engine 3 as well. The printer engine 3, based on the processing instructions for printing, begins processes for printing (that is, adhesive heater temperature adjustment) separate from the image processing of the printer controller 2.

As described above, in the image-forming apparatus according to the third embodiment of the present invention, no power is supplied to the printer engine 3 during standby.

A description will now be given of an image-forming apparatus according to a third embodiment of the present invention, with reference to the accompanying drawings.

In the image-forming apparatus according to the third embodiment of the present invention, the power control unit 51, when in standby, shuts OFF power to the printer controller 2 (except for the communications processor 12) and the printer engine 3. It should be noted that the structure and function of the printer control circuit of the image-forming apparatus according to the third embodiment of the present invention are identical to those depicted in FIG. 3 and FIG. 4, and so a description thereof is omitted.

A description will now be given of the processes performed by the power control unit 51 according to a third embodiment of the present invention, with reference to the flow chart in FIG. 5.

In step S23, when the present process begins, the supply of power to all parts of the apparatus except for the communications processor 12 of the printer controller 2 is turned OFF. Power to the communications processor 12 is left ON in order to process commands other than print commands, such as printer designation and status, to the personal computer when the image-forming apparatus power switch is turned ON.

Next, the process proceeds to a step S24, in which it is determined whether or not there is data destined for the apparatus itself from the personal computer via the spread spectrum communication circuit 53. If the address attached to the data received at the spread spectrum communication circuit 53 is the same as the station address of the apparatus itself (IP address), then the apparatus detects that received data is present. At this point, if there is data destined for the apparatus itself (that is, YES in step S24), then the process proceeds to step S25, where it is determined whether or not the data received is image data.

At this point, if the data received is determined to be image data (that is, YES in step S25), then in step S26 power is turned ON to the printer controller 2 (including the communications processor 12) and the printer engine 3 (including the adhesive unit control circuit 27), and the image data received is sent to the printer controller 2. The power control unit 51 then instructs the printer engine 3 to begin adjusting the temperature of the adhesive heater (in step S27) and completes processing by, for example, setting a process-complete flag (FLG) in step S28, thus completing processing by the power control unit 51. The printer engine 3 is thus put into a print-enable mode and begins processing.

A description will now be given of an image-forming apparatus according to a fourth embodiment of the present invention, with reference to the accompanying drawings.

In the image-forming apparatus according to the fourth embodiment of the present invention, if it is possible to determine a print mode from the data received, then by pre-setting the target temperature based on that mode any overheating of the adhesive heater can be prevented and the time needed to reach the target temperature can be shortened. It should be noted that the structure and printing operation of the printer control circuit of the fourth embodiment of the present invention are identical to those depicted in FIG. 3 and FIG. 4, and so a description thereof is omitted.

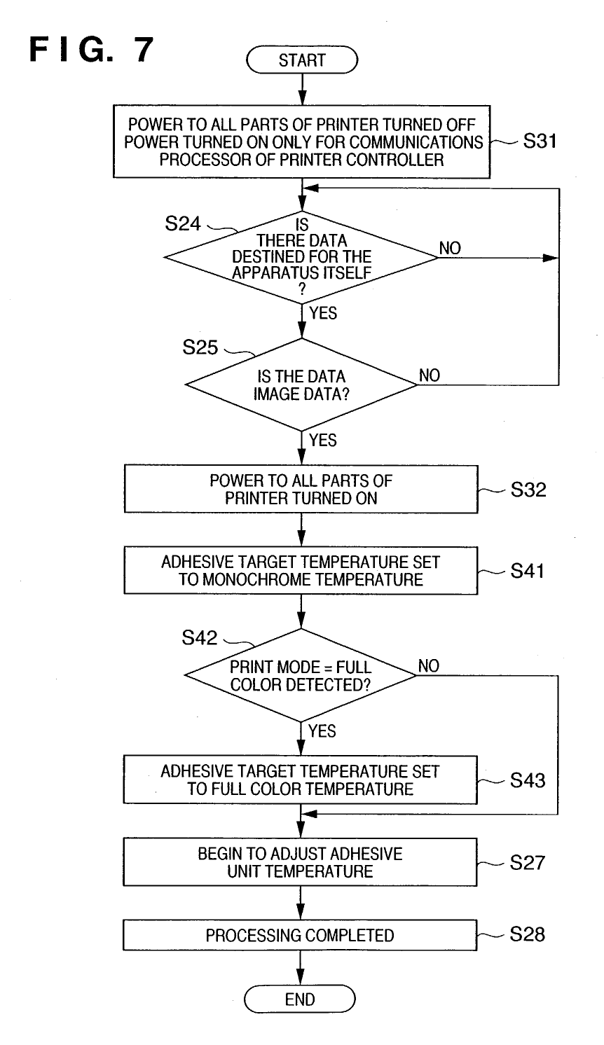

FIG. 7 is a flow chart showing processes performed by a power control unit in a fourth embodiment of the present invention.

When the present process is commenced, steps S31, S24, S25 and S32 are executed in that order. These processes are the same as those described with reference to the third embodiment above. That is, for example, in step S31, the supply of power to all parts except for the communications processor 12 of the printer controller 2 (in other words, to the printer controller 2 except for the communications processor 12 and the printer engine 3) is turned OFF. However, power to the communications processor 12 remains ON. In the event that there is image data with the originating station address, then in step S32 the power is turned ON to the printer controller 2 (including the communications processor 12) and the printer engine 3 (including the adhesive unit control circuit 27), and the image data received is sent to the printer controller 2.

Next, after the processes of step S32 are completed, the process proceeds to step S41, the adhesive target temperature is set to a monochrome temperature, and this setting information is passed on to the image processor 21. The monochrome temperature is used as the default setting here because the monochrome temperature is lower than the full color temperature. When it is determined from the data received that the print mode is full color (that is, YES in step S24), then the setting temperature is reset to full color (in step S34), this setting information is passed on to the image processor 21 and, as with FIG. 5, the process proceeds to steps S27 and S28 in that order, thus completing processing by the power control unit 51.

As described above, in the image-forming apparatus according to the fourth embodiment of the present invention, the power control unit 51 not only shuts off the supply of power to the printer controller 2 and the printer engine 3 when the apparatus is in standby mode but also, by pre-setting the adhesive target temperature in the print mode, achieves a reduction in power consumption equivalent to further having the power turned OFF in standby mode, and can thus prevent the overheating of the adhesive heater as well as shorten the time needed to reach the target temperature.

A description will now be given of an image-forming apparatus according to a fifth embodiment of the present invention, with reference to the accompanying drawings.

It should be noted that, in the image-forming apparatus according to the fifth embodiment of the present invention, a monitor timer is activated as soon as it is determined that the data detected by the spread spectrum communication circuit 53 contains an instruction to print. It should be noted that, with respect to power control, the control described with reference to FIG. 7 or with respect to the second, third and fourth embodiments described above may be substituted for that of FIG. 5.

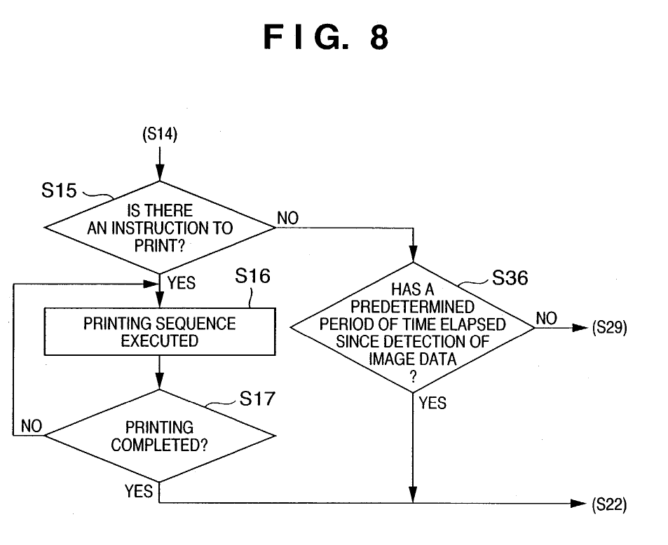

FIG. 8 is a flow chart showing steps in a printing operation of a fifth embodiment of the present invention.

It should be noted that the processes preceding that of step S15 shown in FIG. 8 are identical to steps S21 through S14 shown in FIG. 4. In other words, the printer engine 3 executes initialization in step S21, and when, in step S22, the apparatus except for the adhesive heater temperature reaches standby mode, awaits the completion of processing by the power control unit 51 in steps S41 and S42. When the processes performed by the power control unit 51 are completed, the adhesive heater temperature is adjusted. In step S29 the process awaits the attainment of the target temperature (standby temperature) by the adhesive unit, and in a step S14, if there is paper, executes the processes of step S15 and the succeeding steps.

In step S15, the printer engine 3 checks whether or not there is an instruction to print from the printer controller 2. If there is an instruction to print, then the process proceeds to step S16 and, as with FIG. 4, the printer engine 3 executes a printing sequence. Then, when the printing operation is completed (in step S17), the process returns to step S22 of FIG. 4, the drive system is returned to a desired standby position, and the process repeats the operations from step S22 onward described above.

If there is no instruction to print from the printer controller 2 (that is, NO in step S15), then the printer engine 3 waits for a predetermined period of time to elapse after the detection of image data. If there is still no instruction to print from the printer controller 2 after such predetermined period of time has elapsed (that is, YES in step S36), then the printer engine 3 cancels the print operation and the apparatus returns to the post-initialization standby mode.

A description will now be given of other and further embodiments of the present invention.

As can be appreciated by those of skill in the art, the object of the present invention may also be achieved by a software program code for achieving the functions of the foregoing embodiments being recorded onto a storage medium (or recording medium) that is supplied to a system or an apparatus, with a computer of that system or apparatus then reading the program code stored ion the recording medium. In such a case, the program code read from the recording medium itself achieves the functions of the above-described embodiments, and the recording medium on which that program code is recorded constitutes the present invention. In addition, the present invention includes also an instance in which the execution of the program code read by the computer not only results in the achievement of the functions of the above-described embodiments but also the operating system (OS) operating in the computer performs part or all of the actual processing based on the instructions of the program code, with the functions of the above-described embodiments being achieved based on that processing.

Moreover, as can be appreciated by those of skill in the art, the present invention also includes an instance in which the functions of the above-described embodiments are achieved by processes executed in whole or in part by a CPU or the like provided in a function expansion card or a function expansion unit based on program code instructions, after the program code read from the recording medium is written to a memory provided in such a function expansion card inserted into the computer or such a function expansion unit connected to the computer.

Furthermore, the present invention can be applied to a system comprising either a plurality of units or a single unit. Needless to say, the present invention can be applied to a case in which the functions of the above-described embodiments can be attained by supplying programs that execute the processes defined by the present system or invention.

The present invention is not limited to the above embodiments and various changes and modifications can be made within the spirit and scope of the present invention. Therefore, to appraise the public of the scope of the present invention, the following claims are made.

What is claimed is:

1. An image-forming apparatus comprising:
a reception unit for receiving data via a power line;
an image-forming unit for forming an image according to the data received by the reception unit; and
a power control unit for controlling power supply to the image-forming unit according to the data received by the reception unit.

2. The image-forming apparatus according to claim 1, wherein the power control unit does not supply power to the image-forming unit in a standby mode.

3. The image-forming apparatus according to claim 1, further comprising a conversion unit for converting the data received by the reception unit into print data,
the conversion unit supplying print data to the image-forming unit.

4. The image-forming apparatus according to claim 3, wherein the power control unit instructs the image-forming unit to begin printing independently of the conversion unit according to the data received by the reception unit.

5. The image-forming apparatus according to claim 3, wherein the power control unit supplies power to the image-forming unit and the conversion unit according to the data received by the reception unit.

6. The image-forming apparatus according to claim 1, wherein the power control unit sets a target temperature of an adhesive heater according to the data received by the reception unit.

7. The image-forming apparatus according to claim 1, wherein the power control unit cancels a printing operation when a time until printing begins exceeds a predetermined period of time.

8. A control method for controlling an image-forming unit, the method comprising the steps of:
receiving data via a power line;
determining whether the received data is data for forming an image by the image-forming unit; and
controlling power supply to the image-forming unit according to the determination result using a power control unit.

9. The control method according to claim 8, wherein the power control unit does not supply power to the image-forming unit in a standby mode in the step of controlling power supply to the image-forming unit.

10. The control method according to claim 8, further comprising a step of instructing the image-forming unit to begin printing independently conversion processing for converting the received data into print data according to the received data.

11. The control method according to claim 8, wherein, in the step of controlling power supply to the image-forming unit, the power control unit supplies power to the image-forming unit and the conversion unit according to the received data.

12. The control method according to claim 8, further comprising the step of setting a target temperature of an adhesive heater according to the received data.

13. A machine-readable control program for causing a computer to control an image-forming apparatus, the program comprising the steps of:
receiving data via a power line;
determining whether the received data is data for forming an image by the image-forming unit; and
controlling power supply to an image-forming unit according to the determination result.
